(19) United States
(12) Patent Application Publication
(10) Pub. No.: US 2006/0064732 A1
(43) Pub. Date: Mar. 23, 2006

(54) Adapter apparatus and network camera control method

(75) Inventors: Kazutoyo Hirosawa, Kanagawa (JP); Hiroshi Matsumoto, Kanagawa (JP); Hideyuki Hanaoka, Tokyo (JP); Kouichi Yoshimatsu, Fukuoka (JP); Tsuyoshi Kurose, Fukuoka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/218,776

(22) Filed: Sep. 6, 2005

(30) Foreign Application Priority Data
Sep. 7, 2004 (JP) P2004-259241
Jun. 27, 2005 (JP) P2005-186302

(51) Int. Cl. H04N 7/173

(52) U.S. Cl. 725/105

(57) ABSTRACT

The adapter apparatus according to the present invention is configured to include a network communicator, a display controller, a video signal generator, an input unit and a camera controller. The network communicator is used to perform communication with a network camera. The display controller generates screen display data, including video images data captured by the network camera via the network communicator. The video signal generator converts screen display data generated by the display controller into video signals compatible with a television receiver, and transmits the converted signals to the television receiver for display. The input unit is used by users to input instructions to the network camera. The camera controller generates predetermined camera control signals based on the instructions from the input unit, and transmits the generated signals to the network camera.

### BACKGROUND OF THE INVENTION

1. Field of the Invention

The present invention relates to an adapter apparatus and a network camera control method that monitor and control a network camera.

2. Description of Related Art

In recent years, so-called network cameras configured with a network interface have been a focus of attention. Such a network camera is connected to a personal computer as a network terminal, whereby video image data or control signals are sent/received between a network camera and a personal computer via the network. By using a personal computer, users are able to monitor video images captured by the network camera as easily as they browse web sites on the Internet, and have the network camera perform predetermined operations by remote control, including panning and tilting (Refer to Related Art 1, for example).

[Related Art 1] Japanese Patent Laid-open Publication 2004-153373

Such conventional technology, however, requires a personal computer for using a network camera. This becomes an obstacle for those who are not familiar with personal computers, thereby discouraging them from using network cameras casually. Furthermore, those who do not possess a personal computer need to prepare a personal computer in addition to a network camera, which puts an extra financial burden on those users.

### SUMMARY OF THE INVENTION

The present invention is provided to address the above-described problem. The main objective of the present invention is to provide an adapter apparatus and a network camera control method that allow users to use a network camera easily and inexpensively without depending on a personal computer.

To solve the above-noted problems, the adapter apparatus according to the present invention is configured to include a network communicator, a display controller, a video signal generator, an input unit and a camera controller. The network communicator is used to perform communication with a network camera. The display controller generates screen display data, including video images captured by the network camera via the network communicator. The video signal generator converts screen display data generated by the display controller into video signals compatible with a television receiver, and transmits the converted signals to the television receiver for display. The input unit is used by users to input instructions to the network camera. The camera controller generates predetermined camera control signals based on the instructions from the input unit, and transmits the generated signals to the network camera.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a functional block diagram illustrating an adapter apparatus according to the present invention;

FIG. 2 is a block diagram illustrating an example of a network camera system configured with the adapter apparatus shown in FIG. 1;

FIG. 3 is a block diagram illustrating a hardware configuration of the adapter apparatus shown in FIG. 1;

FIG. 4 shows an external appearance of a remote controller shown in FIG. 1;

FIG. 5 is a block diagram illustrating a hardware configuration of the remote controller shown in FIG. 1;

FIG. 6 is a functional block diagram illustrating a network camera shown in FIG. 1;

FIG. 7 is a flowchart illustrating operations performed by the adapter apparatus shown in FIG. 1;

FIG. 8 is a flowchart illustrating a video image display process shown in FIG. 7;

FIG. 9 shows a function select screen displayed on a television receiver shown in FIG. 1;

FIG. 10 shows a camera operation screen displayed on the television receiver shown in FIG. 1;

FIG. 11 shows how the screen changes at the television receiver shown in FIG. 1, when camera functions are selected;

FIG. 12 shows a timer-recording screen displayed on the television receiver shown in FIG. 1;

FIG. 13 is a flowchart illustrating a timer-recording process shown in FIG. 7;

FIG. 14 shows a sensor mode setting screen displayed on the television receiver shown in FIG. 1;

FIG. 15 shows how the screen changes at the television receiver shown in FIG. 1 with detection by the sensor;

FIG. 16 shows a sensor detection setting screen displayed on the television receiver shown in FIG. 1;

FIG. 17 is a flowchart illustrating another notification process performed by the adapter apparatus shown in FIG. 1;

FIG. 18 shows an example of a network camera system configured with the adapter apparatus shown in FIG. 1; and

FIG. 19 shows another example of a network camera system configured with the adapter apparatus shown in FIG. 1.

### DETAILED DESCRIPTION OF PREFERRED EMBODIMENTS

The embodiments of the present invention are explained in the following, in reference to the above-described drawings.

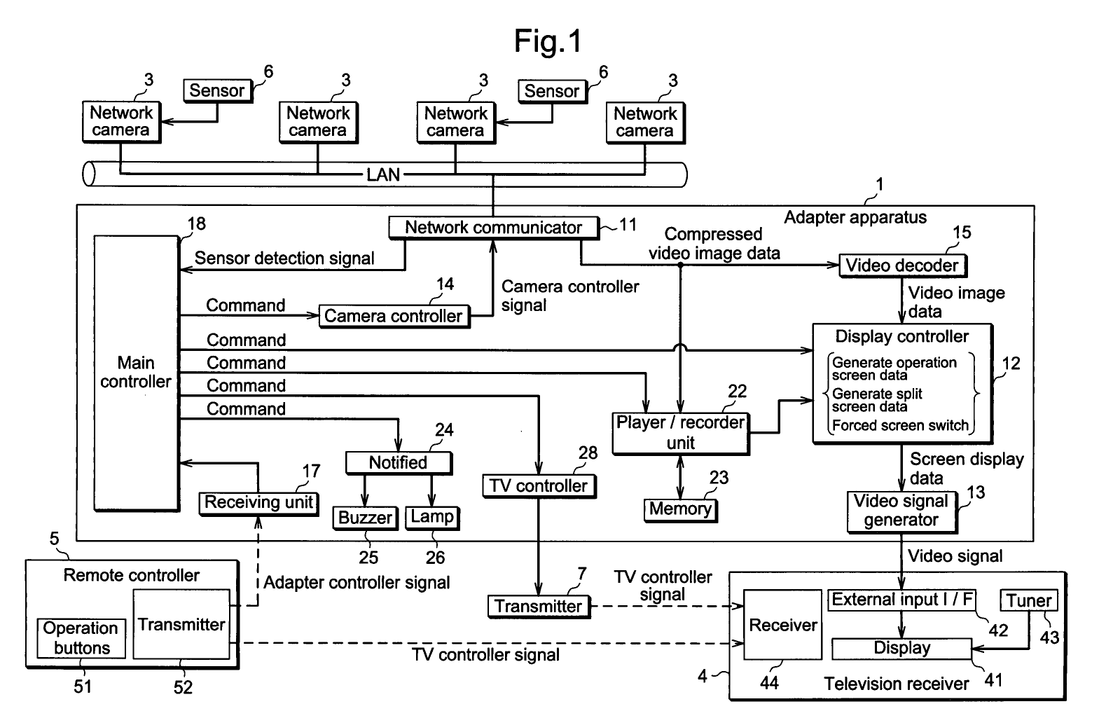

FIG. 1 is a functional block diagram illustrating an adapter apparatus according to the present invention. Adapter apparatus 1 is provided between network camera 3 and television receiver 4. Adapter apparatus 1 controls to display on television receiver 4 video images captured by network camera 3, and controls network camera 3. Adapter apparatus 1 includes network communicator 11, display controller 12 and video signal generator 13. Network communicator 11 performs communication with network camera 3 via the network (LAN). Display controller 12 generates screen display data based on video images captured by network camera 3 via network communicator 11. Video signal generator 13 converts screen display data generated by display controller 12 into video signals compatible with television receiver 4.

Video signal generator 13 outputs standard video signals that can be input into external input interface 42 of television receiver 4. Video signal generator 13 outputs, for example, composite video signals that meet the NTSC (National Television Standards Committee) standards. Television receiver 4, when displaying images on display 41, may switch between a display mode for program image data received by tuner 43 and a display mode for image data input by external input interface 42. The display mode at television receiver 4 is switched to an external input display mode for displaying instructions input by remote controller 5 when adapter apparatus 1 monitors and controls network camera 3.

Video decoder 15 is provided prior to display controller 12. Video decoder 15 decodes compressed video images captured by network camera 3.

Adapter apparatus 1 includes receiving unit 17 that receives control signals from remote controller 5. When receiving unit 17 receives control signals, the control signals being transmitted from transmitter 52 by operating operation buttons 51 on remote controller 5, main controller 18 analyses instructions (operation information) included in the control signals. Based on the analysis results, main controller 18 provides predetermined commands to display controller 12 of adapter apparatus 1 or other units, which are described later.

Remote controller 5 is equipped with buttons that control adapter apparatus 1 and television receiver 4 individually as described later. Adapter control signals for controlling adapter apparatus 1 are transmitted from transmitter 52 by operating buttons for adapter apparatus 1. Television control signals for controlling television receiver 4 are transmitted from transmitter 52 by operating buttons for television receiver 4. Television receiver 4 receives, at receiver 44, television control signals from remote controller 5, and performs predetermined operations based on instructions included in the television control signals.

Adapter apparatus 1 generates, at display controller 12, screen display data based on operation screen data in accordance with instructions via remote controller 5. Adapter apparatus 1 includes camera controller 14. Camera controller 14 generates predetermined camera control signals for controlling network camera 3 based on operations performed at remote controller 5 when a user operates remote controller 5, watching an operation screen displayed on television receiver 4. Camera controller 14 transmits the predetermined camera control signals to network camera 3. Camera controller 14 is capable of generating camera control signals for controlling network camera 3, including panning, tilting and zooming, and of instructing network camera 3 to perform those operations.

Adapter apparatus 1 includes player/recorder unit 22. Player/recorder unit 22 performs a recording process whereby video images captured by network camera 3 are stored in memory 23 based on recording instructions via remote controller 5, and player/recorder unit 22 performs a replay process whereby the video images stored in memory 23 are retrieved.

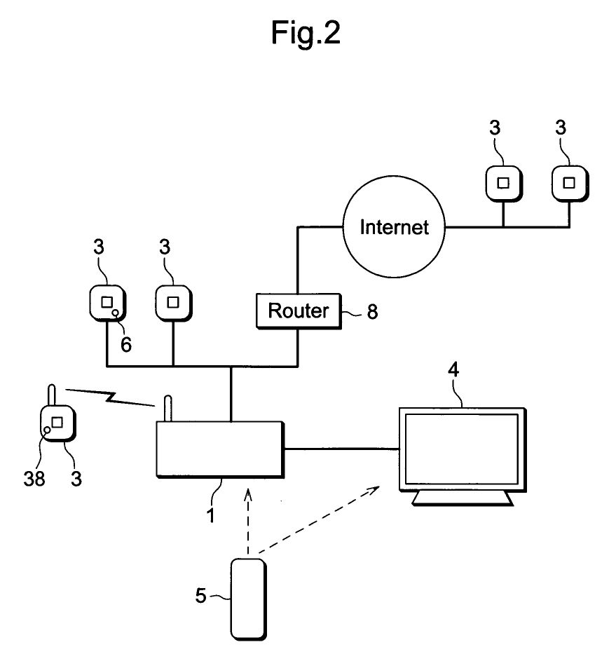

FIG. 2 is a block diagram illustrating an example of a network camera system configured with adapter apparatus 1 shown in FIG. 1. In the network camera system, adapter apparatus 1 is connected to a plurality of network camera 3 via wired or wireless LANs. In addition, adapter apparatus 1 is connected to the Internet via router 8, thereby enabling predetermined operations including reception of video images captured by remotely located network camera 3 connected to the Internet. The video images captured by the remotely located network camera 3 may be displayed on television receiver 4.

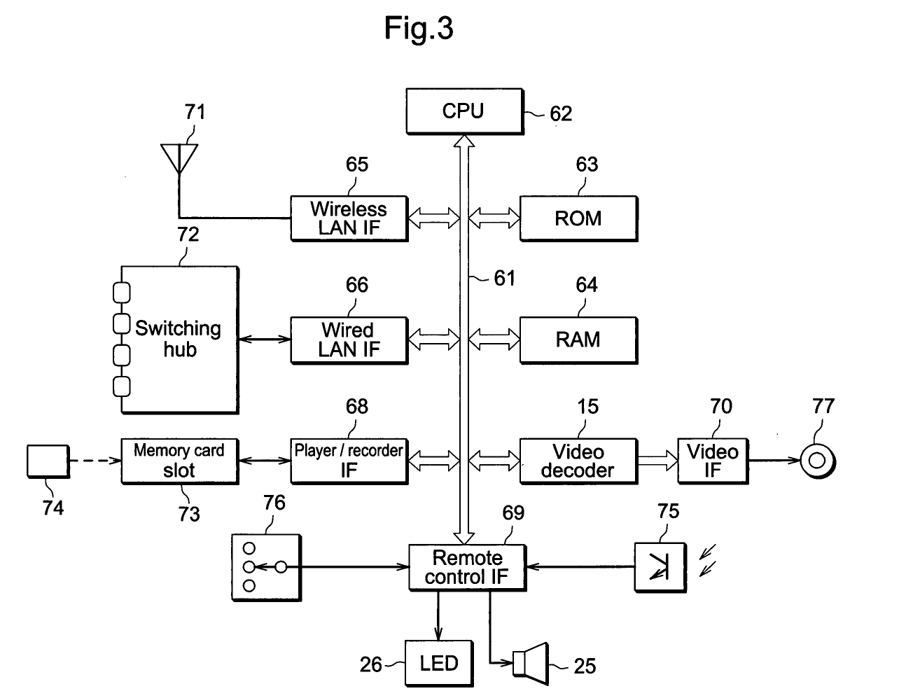

FIG. 3 is a block diagram illustrating a hardware configuration of adapter apparatus 1 shown in FIG. 1. In adapter apparatus 1, CPU 62, ROM 63, RAM 64, wireless LAN interface 65, wired LAN interface 66, player/recorder interface 68, remote control interface 69 and video decoder 15 are interconnected via bus 61.

CPU 62 comprehensively controls individual functions. ROM 63 stores programs and various setting information needed for control by CPU 62. RAM 64 provides a work area for control by CPU 62. CPU 62 executes predetermined programs, thereby operating main controller 18, display controller 12 and camera controller 14 shown in FIG. 1.

Wireless LAN antenna 71 is connected to wireless LAN interface 65. As shown in FIG. 2, it is possible to communicate with network camera 3 that has a wireless LAN function. Switching hub 72 equipped with a plurality of wired LAN ports is connected to wired LAN interface 66. As shown in FIG. 2, switching hub 72 may communicate with a plurality of network cameras 3 that have wired LAN functions. Wireless LAN interface 65, wireless LAN antenna 71, wired LAN interface 66, switching hub 72 function as network communicator 11 shown in FIG. 1.

Video interface 70 is connected to video decoder 15. Video interface 70 functions as video signal generator 13 shown in FIG. 1. Video image data decoded by video decoder 15 are converted into video signals compatible with television receiver 4, after which the generated video signals are output from video output terminal 77. Video output terminal 77 is connected to a video input terminal via a video cable, the video input terminal being provided in external input interface 42 of television receiver 4 shown in FIG. 1. Further, another configuration is possible whereby adapter apparatus 1 and television receiver 4 are wirelessly connected.

Memory card slot 73 is connected to player/recorder interface 68. Memory card 74 as memory 23 shown in FIG. 1 is inserted into memory card slot 73. At recording, video images captured by network camera 3 are stored in memory card 74. At replaying, the video images stored in memory card 74 are retrieved. Player/recorder interface 68 and memory card slot 73 function as player/recorder unit 22 shown in FIG. 1.

Memory 23 shown in FIG. 1 may be configured with a memory other than memory card 74, for example, such as a hard disk drive.

Light receiving element 75, setting switch 76, buzzer 25 and lamp (LED) 26 are connected to remote control interface 69. Light receiving element 75 receives infrared signals (control signals) transmitted from remote controller 5. Setting switch 76 is used to switch various operation modes, including an auto-setting mode. Buzzer 25 notifies operation errors and the like. Lamp 26 notifies LAN connection status and the like. Light receiving element 75 and remote control interface 69 function as receiving unit 17 shown in FIG. 1. Remote control interface 69 functions as notifier 24 shown in FIG. 1.

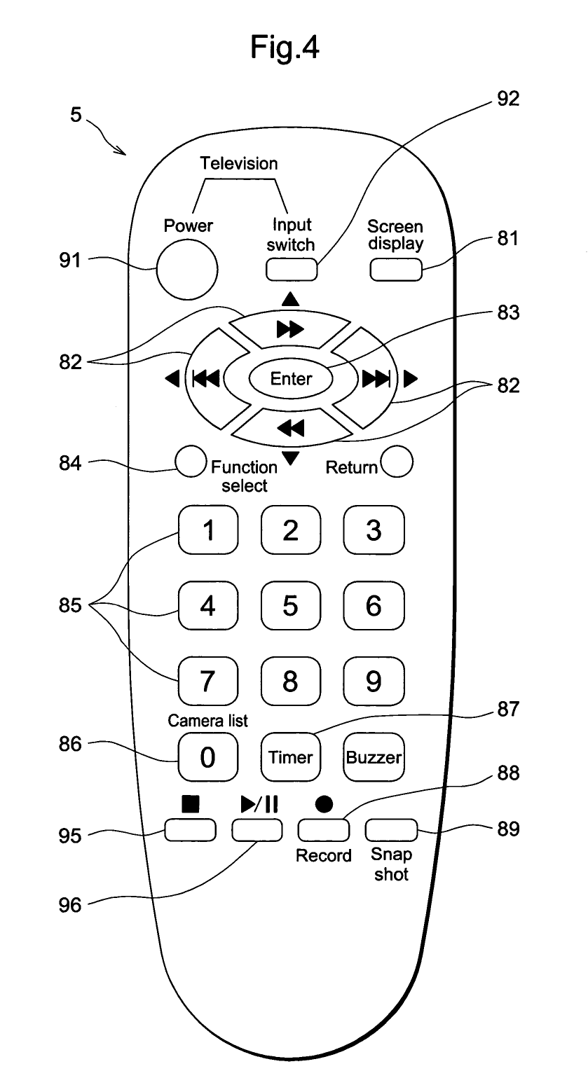

FIG. 4 shows an external appearance of remote controller 5 shown in FIG. 1. Remote controller 5 includes various operation buttons as operation buttons 51 shown in FIG. 1. Operation buttons 51 include screen display button 81, left, right, up and down cursor button (direction button) 82, enter button 83, function select button 84, numeric buttons 85, camera list button 86, timer button 87, record button 88, snap shot button 89, stop button 95, play/pause button 96, etc.

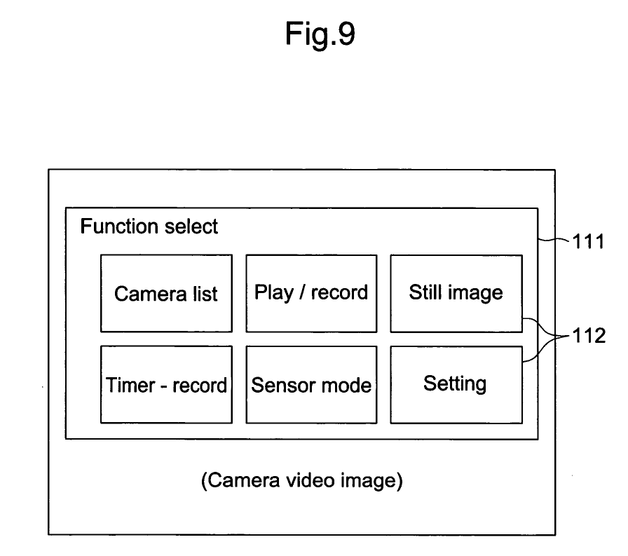

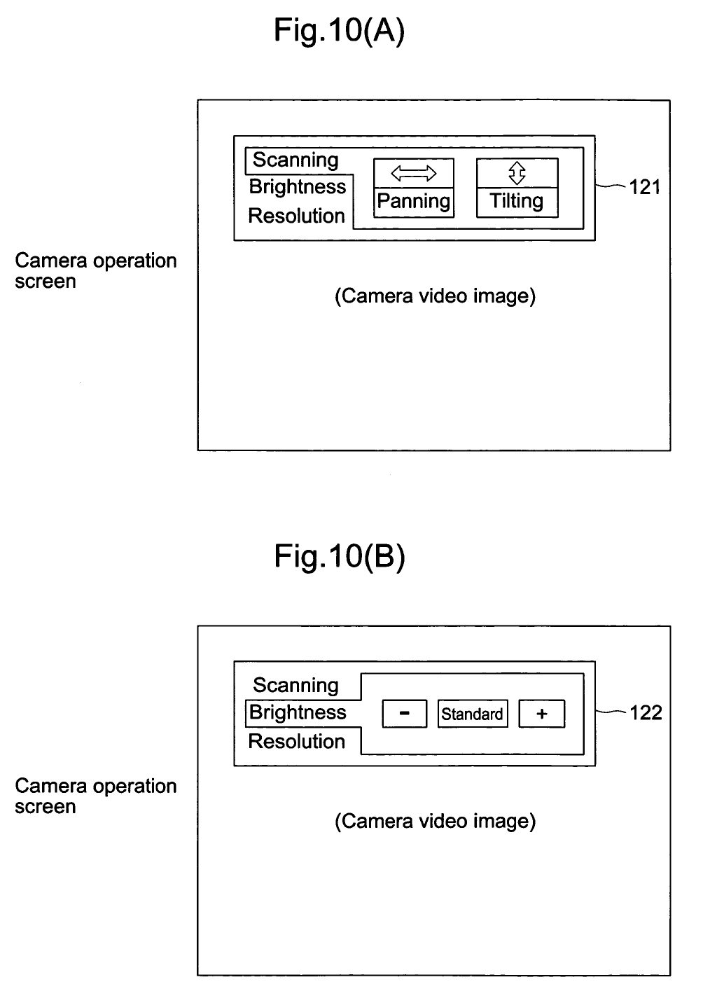

Screen display button 81 is used to request a camera operation screen (see FIG. 10) for operating network camera 3. When setting various functions of adapter apparatus 1, function select button 84 is used to request a function select screen (see FIG. 9) for selecting a function for such settings.

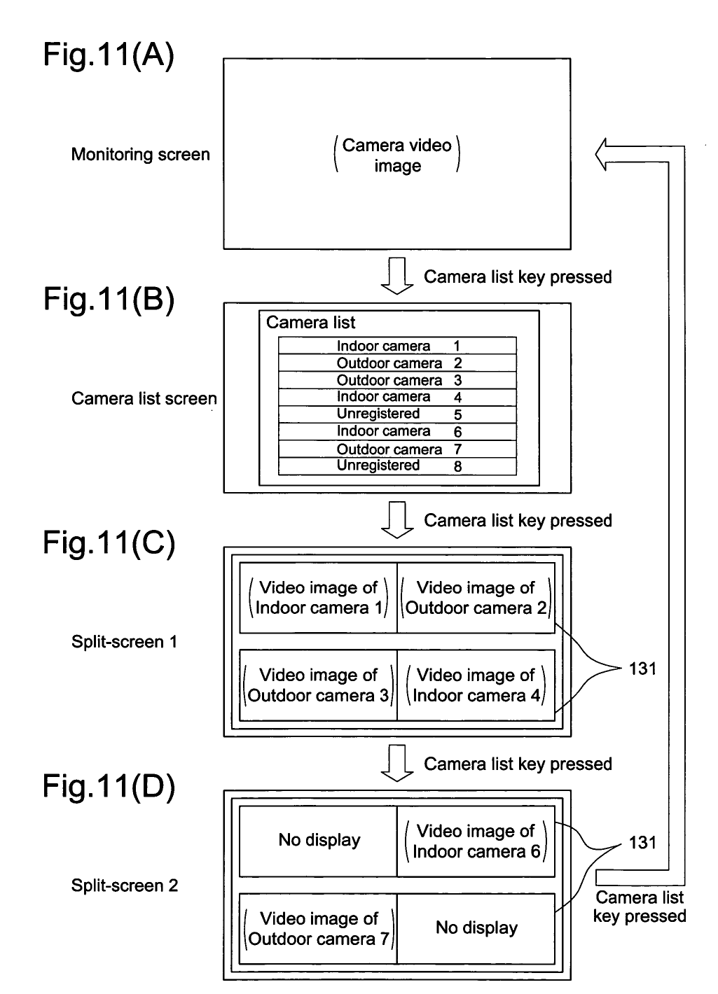

Numeric buttons 85 are used to select one of network cameras 3 by a specified number corresponding to the one of network cameras 3 and to request a display screen for displaying video images captured by the selected network camera 3 (direct selection). On the other hand, camera list button 86 is used to request a screen (see FIG. 11) for displaying the list of registered network cameras 3. It is possible to select one of network cameras 3 using the requested screen (list selection).

Timer button 87 is used to set a timer-recording function for recording video images captured by network camera 3 at a designated time. Record button 88 is used to start a recording process (a real-time recording process) of live video images captured by network camera 3. Snap shot button 89 is used to perform a process (a snap shot recording process) for recording still images of video images captured by network camera 3.

Remote controller 5 further includes power button 91 and input switch button 92 for operating television receiver 4. Television receiver 4 may be operated via remote controller 5 without using another remote controller for television receiver 4.

Power button 91 is used to turn television receiver 4 ON (powered) or OFF (on standby). Input switch button 92 is used to switch images displayed on display 41 of television receiver 4 shown in FIG. 1 between broadcast program images received from tuner 43 and images received from external input interface 42.

Input methods for remote controller 5 are not limited to input via operation buttons; input can be made also by operation dials, for example.

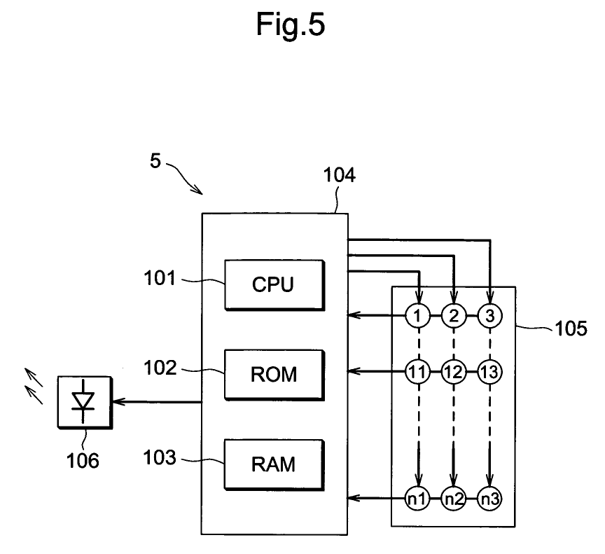

FIG. 5 is a block diagram illustrating a hardware configuration of remote controller 5 shown in FIG. 1. Remote controller 5 is configured with controller 104, switch unit 105 and infrared luminous element 106. Controller 104 includes CPU 101, ROM 102 and RAM 103. Switch unit 105 includes ON/OFF switches that operate in accordance with button operations shown in FIG. 4.

Controller 104 generates control signals including predetermined data codes corresponding to signals output from switch unit 105. Controller 104 then operates infrared luminous element 106 to transmit the control signals. Adapter apparatus 1 and television receiver 4 operate in two different data code classifications for control signals. Special codes are assigned to control signals for adapter apparatus 1, while codes corresponding to television receiver 4 are assigned to control signals for television receiver 4.

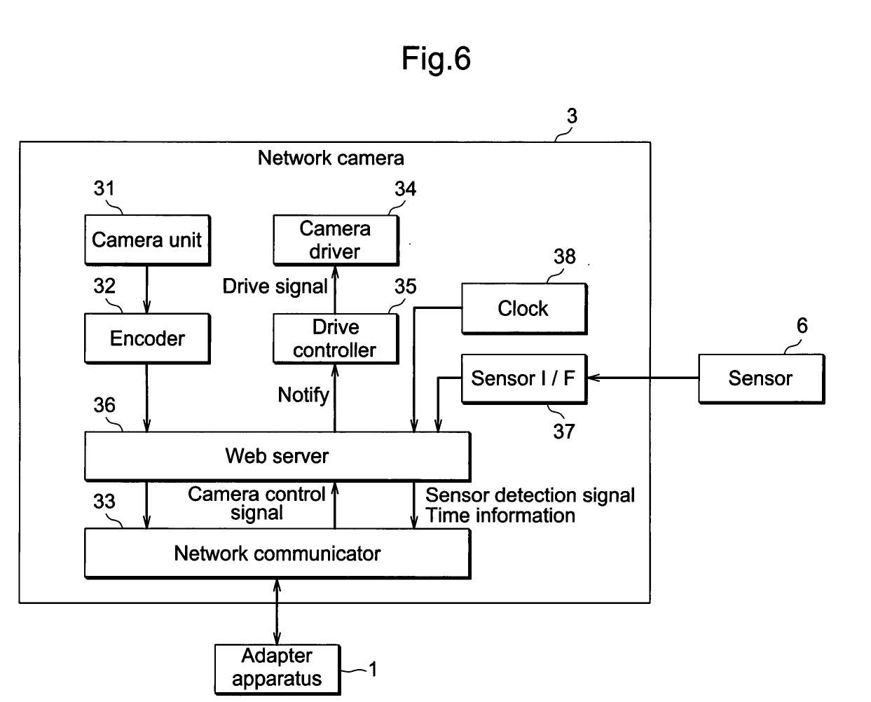

FIG. 6 is a functional block diagram illustrating network camera 3 shown in FIG. 1. Network camera includes camera unit 31, encoder 32, web server 36 and network communicator 33. Camera unit 31 has an image capturing device including a CCD (charged-coupled device). Encoder 32 encodes and compresses video image data output from camera unit 31. Web server 36 receives, from adapter apparatus 1 via CGI (Common Gateway Interface), a request for transmitting video images captured by network camera 3. Network communicator 33 performs communication with adapter apparatus 1 via the network (LAN). Network communicator 33 transmits to adapter apparatus 1 compressed video image data generated by encoder 32. Video image data are generated in the JPEG (Joint Photographic Experts Group) format. When the video image data are motion pictures, they are generated in the motion JPEG.

Network camera 3 includes camera driver 34, drive controller 35 and web server 36. Camera driver 34 drives camera unit 31 under various operations, including panning (moving camera unit 31 horizontally), tilting (moving camera unit 31 vertically) and zooming. Drive controller 35 outputs drive signals to camera driver 34. Web server 36 receives camera control signals from adapter apparatus 1 via CGI. Upon receiving the camera control signals from adapter apparatus 1, web server 36 transmits, to drive controller 35, drive instructions in accordance with the camera control signals. Drive controller 35 outputs to camera driver 34 drive signals corresponding to the drive instructions. Camera driver 34 performs predetermined operations based on the drive signals output from drive controller 35.

Network camera 3 includes sensor interface 37 into which output signals from sensor 6 are input. Detection signals are transmitted from web server 36 to adapter apparatus 1 via network communicator 33, based on the output signals from sensor interface 37. Sensor interface 37 does not need to be provided with all network cameras 3 connected to adapter apparatus 1.

Sensor 6 may be, for example, a motion sensor that detects human motions based on temperature changes caused by infrared rays omitted from the human body.

Network camera 3 further includes clock 38. Time information obtained by clock 38 is transmitted from web server 36 to adapter apparatus 1 via network communicator 33. Clock 38 does not need to be provided with all network cameras 3 connected to adapter apparatus 1.

Network communicator 33 has wired LAN and/or wireless LAN functions. Network communicator 33 equipped with both functions may use one of the functions by a setting switch selecting one of the wired mode and the wireless mode, the setting switch being provided with network camera 3.

Adapter apparatus 1 may automatically establish initial settings for a communication between adapter apparatus 1 and network camera 3 by default without intervention of users. In this automatic initial setting process, various items are set, based on the communication between adapter apparatus 1 and web server 36 of network camera 3 via CGI. The items include apparatus information (e.g., a user name, a password, and a power supply frequency of network camera 3), network information (e.g., an IP address and a net mask of adapter apparatus 1, and an IP address and a net mask of network camera 3) and wireless information (e.g., a communication mode, a communication channel, an ESS-ID and encode information). This automatic setting process is performed by shifting setting switch 76 (see FIG. 3) of adapter apparatus 1 to an automatic setting mode before rebooting (reset) adapter apparatus 1. Further, when router 8 is connected to adapter apparatus 1, router 8 is automatically set as well.

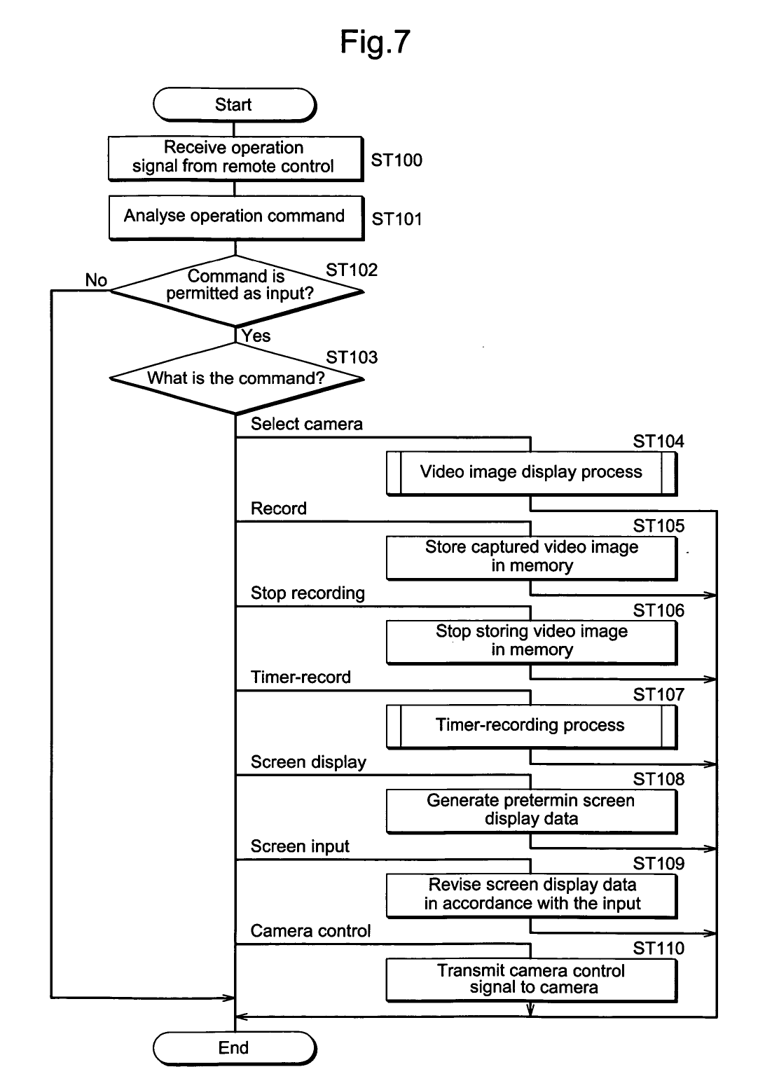

FIG. 7 is a flowchart illustrating operations performed by adapter apparatus 1 shown in FIG. 1. When adapter apparatus 1 receives, at receiving unit 17, a control signal from remote controller 5 (step 100), main controller 18 analyses the operation requested by the user, based on the current status of the screen display and the received control signal (step 101). When the result shows that the received control signal is not permitted as input for the currently displayed screen content (step 102: NO), the control signal is ignored to terminate the process. When the received control signal is permitted as input for the currently displayed screen content (step 102: YES), a predetermined operation is executed in accordance with the received control signal (step 104-110).

Here, main controller 18 determines which control signal is permitted in relation to which screen is displayed.

In FIG. 7, for example, when a command corresponding to the received control signal indicates “select camera”, a process for displaying, on television receiver 4, video images captured by network camera 3 is executed (step 104). When the command indicates “record”, player/recorder unit 22 performs a process for storing in memory 23 video images (motion and still pictures) being captured by network camera 3 (step 105). When the command indicates “stop recording”, a process for storing the video images in memory 23 is stopped (step 106). When the command indicates “timer-record”, a timer-recording process is performed in accordance with the user's input (step 107).

When the command indicates “screen display”, display controller 12 performs a process for generating screen display data for various operation screens described below (step 108). When a video image captured by network camera 3 is already being displayed on display 41 at this step, a process for generating on-screen screen display data is performed to superimpose an operation guide window upon the video image being displayed on display 41.

When the command indicates “screen input”, processes in accordance with the user's input are performed at corresponding units. In addition, display controller 12 performs a process for revising the screen display data in accordance with the user's input (step 109). When the command indicates “camera control”, camera controller 14 performs a process for transmitting a camera control signal to a corresponding network camera 3 in order to operate the network camera 3 (step 110).

More specifically, when function select button 84 on remote controller 5 is pressed while a video image captured by one of network cameras 3 is displayed on television receiver 4, it is determined that “function select button 84” is permitted to be pressed for input (step 102). In this case, the operation requested by the user is analyzed, at step 101, as displaying menu display window 111 shown in FIG. 9, and the command is determined to indicate “screen display” at step 103. The process then proceeds to step 108 in which the screen display data are generated whereby menu display window 111 shown in FIG. 9 is superimposed on the video image being displayed on television receiver 4.

While the screen display data are displayed, left, right, up and down cursor buttons 82, camera list button 86 and the like are permitted as input, although numeric buttons 85 and the like are not permitted as input. When camera list button 86 is pressed at this step, or when camera list button 86 is pressed in the state shown in FIG. 11(A), the press of the button is analyzed as a command for displaying the list of network cameras 3. In this case, the command is determined to indicate “screen display” at step 103. The process then proceeds to step 108 in which the screen display data described in FIG. 11(B) are generated and displayed.

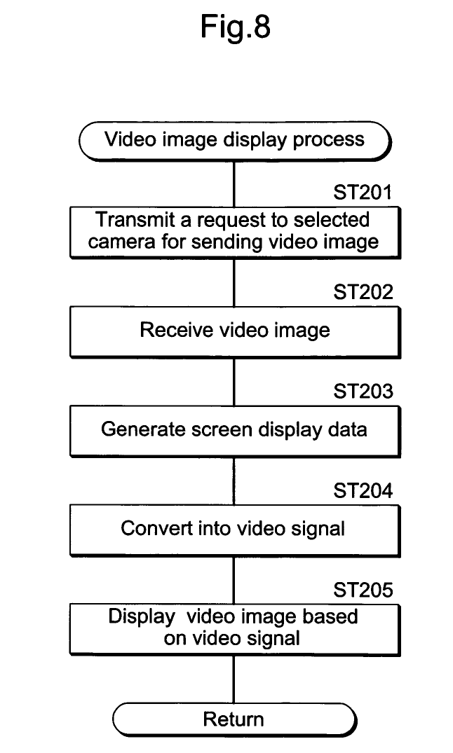

Then, when camera list button 86 is pressed again, the press of the button is analyzed as a command for displaying video images captured by network camera 3. In this case, the command is determined to indicate “select camera” at step 103. The process then proceeds to step 104 in which a process for displaying the video image described in FIG. 8 is executed (detailed descriptions are provided later).

When four network cameras 3, i.e. cameras 1,2,3 and 4, are automatically selected, video images captured by these four network cameras 3 are displayed on television receiver 4 as shown in FIG. 11(C).

In another example, when screen display button 81 on remote controller 5 is pressed while a video image captured by one of network cameras 3 is displayed on television receiver 4, it is determined that “screen display button 81” is permitted as input (step 102). Then, the press of the button is analyzed as a command for displaying guide display window 121 shown in FIG. 10(A), and the command is determined to indicate “screen display” at step 103. The process then proceeds to step 108 in which screen display data are generated whereby guide display window 121 shown in FIG. 10(A) is superimposed on the video image being displayed on television receiver 4.

When cursor button 82 is pressed to move down and to select a next item while this screen image is displayed, the command is determined to indicate “screen input” at step 103. The process then proceeds to step 109 in which brightness adjustment is selected (guide display window 122 shown in FIG. 10(B)).

When left and right cursor buttons 82 are pressed to control a panning direction while the screen display data shown in FIG. 10(A) are displayed, the command is determined to indicate “camera control” at step 103. The process then proceeds to step 110 in which main controller 18 transmits a command to camera controller 14. Camera controller 14 then transmits, to network camera 3, a camera control signal for changing the direction of network camera 3. Then, a video image with a changed direction is captured, and the newly captured video image is shown in FIG. 10(A).

FIG. 8 is a flowchart illustrating a video image display process shown in step 104 of FIG. 7. First, based on a command from main controller 18, camera controller 14 performs a process for transmitting, to a network camera 3 selected via remote controller 5, a request for sending a video image (step 201). In response to this request, the network camera 3 starts a process for sending the video image. Network communicator 11 then receives the video image from the network camera 3 (step 202). Then, display controller 12 generates screen display data based on the video image (step 203); video signal generator 13 converts the screen display data into video signals (step 204); and television receiver 4 displays the video image captured by the network camera 3 based on the video signals transmitted from video signal generator 13 (step 205).

When the video image captured by the selected network camera 3 is already being displayed on television receiver 4, step 201 can be skipped. Further, when video images captured by cameras other than the selected one are already being displayed on television receiver 4, a request for stopping the transmission of the video images also can be sent to those unselected cameras.

FIG. 9 shows a function select screen, and the function select screen is the main screen provided for operating adapter apparatus 1. The function select screen is used, when the user of adapter apparatus 1 performs various settings for adapter apparatus 1, to select a function for which settings are needed. Relevant screen display data are displayed on television receiver 4 by pressing function select button 84 (see FIG. 4) on remote controller 5, and by proceeding the process to step 108 described in FIG. 7. When a captured video image is being monitored at that step, an on-screen display (overview display) is performed. Then, menu display window 111 is superimposed on the video image captured by network camera 3. Menu display window 111 contains a plurality of display select sections 112 corresponding to each of a plurality of function settings. Further, when a television broadcast program image is being displayed, menu display window 111 is superimposed on the broadcast program image.

Within menu display window 111, the plurality of display select sections 112 corresponding to items, i.e. “camera list”, “play/record”, “still image”, “timer-record”, “sensor mode” and “setting”, are arranged. After selecting an item by pressing cursor buttons 82 (see FIG. 4) of remote controller 5 and determining the selection by pressing enter button 83, the screen display data switches into a setting screen corresponding to the selected item.

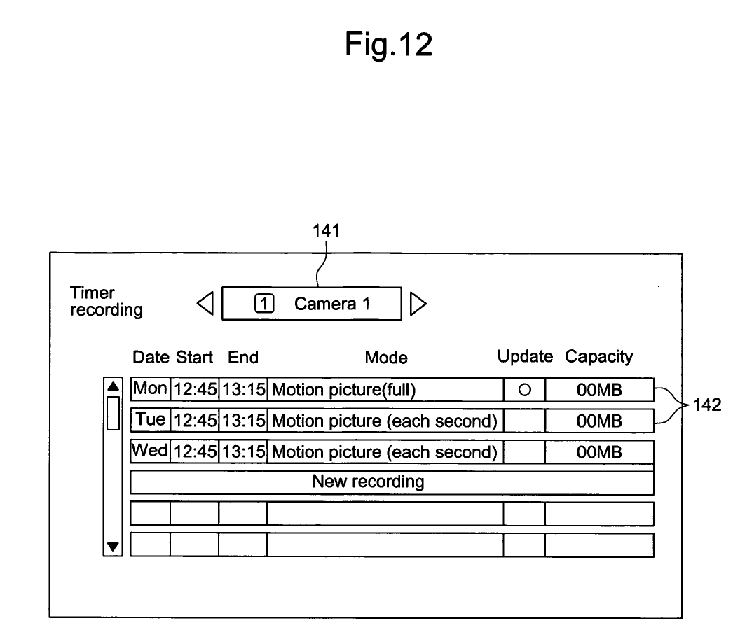

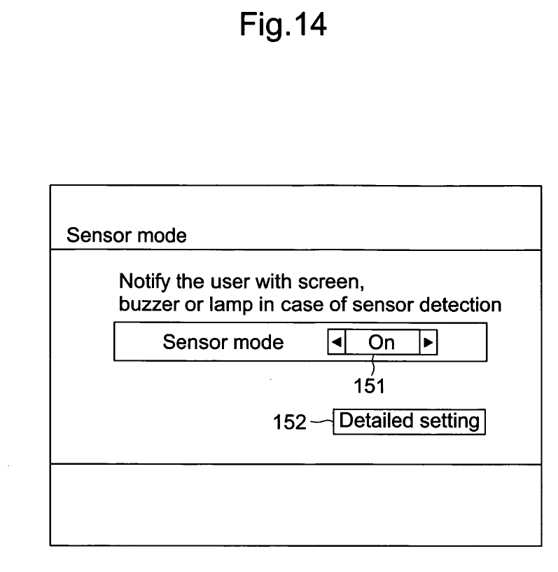

When “camera list” is selected, a setting screen (see FIG. 11(B)) is displayed for listing all network cameras 3 to be described later. When “play/record” is selected, a setting screen is displayed for recording or playing video images via a storage medium such as memory card 74. When “still image” is selected, a setting screen is displayed for recording or playing still images via a storage medium such as memory card 74. When “timer-record” is selected, a setting screen is displayed for timer-recording to be described later (see FIG. 12). When “sensor mode” is selected, a setting screen is displayed for performing alarm operations in accordance with detection by sensor 6 to be described later (see FIG. 14). When “setting” is selected, a setting screen is displayed for the initial settings of adapter apparatus 1 (no figure) and for various settings of network camera 3 (see FIG. 10).

FIG. 10 shows a camera operation screen displayed on television receiver 4 shown in FIG. 1. The camera operation screen is displayed on television receiver 4 via two routes: by selecting “setting” on the function select screen shown in FIG. 9 to display the setting screen for network camera 3 or by pressing screen display button 81 (see FIG. 4) of remote controller 5. Guide display windows 121 and 122 for guiding operation procedures of network camera 3 are then superimposed on video images being captured by network camera 3 in the on-screen display mode. This allows the user to operate network camera 3 by remote control while watching the video images captured by network camera 3. Operation items in this example include scanning, brightness, and resolution. These items may be adjusted by selecting one of left, right, up and down cursor buttons 82 of remote controller 5.

In the above, the descriptions concerned a case where guide display windows 121 and 122 are superimposed on the video images captured by network camera 3 in the on-screen mode. It is also possible to display only video images on the screen without guide display windows, since the guide display windows may obstruct vision for monitoring the video images. In that case, the user may operate network camera 3 by remote control while watching only the video images captured by network camera 3 without guide display windows.

As shown in FIG. 10(A), the operation items for “scanning” allow the user to request various operations for panning and tilting to change the viewing angle of network camera 3 in horizontal and vertical directions. More specifically, when “panning” is selected and when it is determined to press one of left and right cursor buttons 82 and to enter button 83 of remote controller 5, a pan-scan is performed. In the pan-scan, the viewing angle is rotated horizontally back and forth and then it returns to the original position. Also, when “tilting” is selected and when it is determined to press one of up and down cursor buttons 82 and to enter button 83 of remote controller 5, a tilt-scan is performed. In the tilt-scan, the viewing angle is rotated vertically back and forth and then it returns to the original position. In addition, a panning operation may be performed by pressing one of left and right cursor buttons 82 of remote controller 5. A tilting operation may be performed by pressing one of up and down cursor buttons 82.

Furthermore, as shown in FIG. 10(B), when “brightness” is selected, it is possible to adjust the brightness of video images captured by network camera 3. More specifically, when “standard” is selected and when it is determined to press one of left and right cursor buttons 82 and to enter button 83 of remote controller 5, standard brightness is adjusted. When “−” is selected, brightness decreases by one notch, and when “+” is selected, brightness increases by one notch.

The operation items of network camera 3 are not limited to the above-noted items, and may include other control items, such as zooming.

FIG. 11 shows how the screen changes on television receiver 4 shown in FIG. 1, when camera functions are selected. As described above, adapter apparatus 1 may perform a direct selection as well as a list selection: the direct selection indicates that the user selects one of network cameras 3 by pressing numeric buttons 85 of remote controller 5 and requests a screen displaying video images captured by the selected network camera 3, while the list selection indicates that the user requests a camera list screen displaying the list of registered network cameras 3 and selects one of the network cameras 3, using the requested screen.

The camera list screen displaying the list of registered network cameras 3 is displayed on television receiver 4 as shown in FIG. 11(B) by pressing camera list button 86 of remote controller 5 while video images captured by network camera 3 are displayed on television receiver 4 as shown in FIG. 11(A) or by selecting “camera list” on the function select screen shown in FIG. 9.

On this camera list screen, registered network cameras 3 are displayed in a predetermined order. In addition, the camera list screen may display characters representing names and the like assigned to the network cameras 3. This allows the user to select one of the network cameras 3 based on those names. Here, when the user selects a desired network camera 3 by pressing one of up and down cursor buttons 82 and entering button 83 of remote controller 5, video images captured by the corresponding network camera 3 are displayed on television receiver 4.

Further, in order to select one of network cameras 3 at display controller 12, adapter apparatus 1 can generate a split-screen. The split-screen displays a plurality of video images captured by a plurality of registered network cameras 3 on television receiver 4 in a manner to divide each of the plurality of the video images into a plurality of display windows 131 which are created by dividing one single screen into the plurality of display windows 131. As shown in FIGS. 11(C) and (D), video images captured by a plurality of network cameras 3 are arrayed in a predetermined order. This allows the user to select one of the network cameras 3 while watching live video images captured by the network cameras 3.

The first split-screen shown in FIG. 11(C) is displayed by pressing camera list button 86 of remote controller 5 while the camera list screen shown in FIG. 11(B) is displayed. Further, when camera list button 86 is pressed while the first split-screen is displayed, the second split-screen shown in FIG. 11(D) is displayed. On these split-screen data, the user selects and determines a desired network camera 3 by pressing one of left, right, up and down cursor buttons 82 and entering button 83 of remote controller 5 or by directly pressing numerical buttons 85 while watching respective video images captured by the network cameras 3. Then, this process exclusively displays one full-screen data for displaying video images captured by one selected network camera 3.

For the display of the split-screen, procedures similar to those shown in FIG. 8 are performed. In this example, each of the plurality of network cameras 3 is assigned to one display window 131 on one of the first and second split-screens in the predetermined order. When camera list button 86 is pressed while the camera list screen is displayed, a request for sending captured video images is transmitted to network cameras 3 corresponding to the selected display windows 131 of the first split-screen. Based on video images captured respectively from those network cameras 3 in response to this request, display controller 12 generates the split-screen data. Then, the first split-screen is displayed on television receiver 4.

When camera list button 86 is further pressed while the first split-screen is displayed, a request for sending captured video images is transmitted to network cameras 3 corresponding to the selected display windows 131 of the second split-screen. Based on video images captured respectively from those network cameras 3 in response to this request, display controller 12 generates the split-screen data. Then, the second split-screen is displayed on television receiver 4.

Adapter apparatus 1 generates, at display controller 12, split-screen display data to display respective video images captured by each of the plurality of network cameras 3 into the corresponding display windows 131. The plurality of display windows 131 are created by dividing one single screen on television receiver 4. Each of the plurality of network cameras 3 is selected by operating remote controller 5. The video images captured by those network cameras 3 are thus displayed simultaneously on the one single screen in a manner similar to the split-screen shown in FIGS. 11(C) and (D). Thus, the user can monitor the plurality of network cameras 3 simultaneously without switching the screen.

For the display of the split-screen, procedures similar to those shown in FIG. 8 are performed. First, as with the above example in FIG. 11, the camera list screen shown in FIG. 11(B) is displayed by pressing camera list button 86. When the plurality of network cameras 3 are selected, a request for sending captured video images is transmitted to the selected plurality of network cameras 3. Based on video images captured respectively by the plurality of network cameras 3 in response to this request, display controller 12 generates the split-screen data. Then, the split-screen displays the video images captured by the selected plurality of network cameras 3 on television receiver 4.

As described above, adapter apparatus 1 includes player/recorder unit 22. Player/recorder unit 22 performs a process for storing, in memory 23, video images captured by network camera 3. In response to a command from main controller 18, player/recorder unit 22 may perform a process for recording the video images captured by network camera 3 in live video images (a real-time recording process), a process for recording video images captured by network camera 3 in still images (a snap-shot recording process), and a process for recording video images at a programmed date and time (a timer-recording process).

Real-time recording is started by pressing record button 88 of remote controller 5 while a video image captured by a desired network camera 3 is displayed on television receiver 4. The desired network camera 3 can be selected through a direct selection with numeric buttons 85 of remote controller 5 shown in FIG. 4 or through a list selection including the cameral list screen or the split-screen shown in FIG. 11. Real-time recording is terminated by pressing stop button 95.

Snap-shot recording is executed by pressing snap shot button 89 of remote controller 5 while a video image captured by a desired network camera 3 is displayed on television receiver 4. The desired network camera 3 can be selected through the direct selection or the list selection.

FIG. 12 shows a timer-recording screen displayed on television receiver 4 as an operation screen for timer-recording. On the timer-recording screen, the user selects one of network cameras 3 for timer-recording, a recording date (the day of the week, a starting time and an ending time) and a recording mode. The timer-recording screen is displayed by selecting “timer-record” on the function select screen shown in FIG. 9.

After one of network cameras 3 is displayed in display select section 141 of the timer-recording screen, a desired network camera 3 can be selected by pressing left and right cursor buttons 82 and pressing numeric buttons 85 of remote controller 5. Further, display select sections 142 for settings of the timer-recording display items including, i.e. the day of the week, a starting time, an ending time and a recording mode. To change such settings, the user selects a corresponding display select section 142. To newly program a time-recording, the user selects “new recording” from display select sections 142 in order to request an input screen (no figure). On the input screen, the user is able to enter settings for respective items by pressing left, right, up and down cursor buttons 82 of remote controller 5.

In timer-recording, adapter apparatus 1 has already obtained, from clock 38 built in network camera 3, time information as shown in FIG. 6. When adapter apparatus 1 is connected to a plurality of network cameras 3 having clocks 38, the user may simply select one of the plurality of network cameras 3 in order to obtain time information. The selection is made based on the priority given to each of the plurality of network cameras 3.

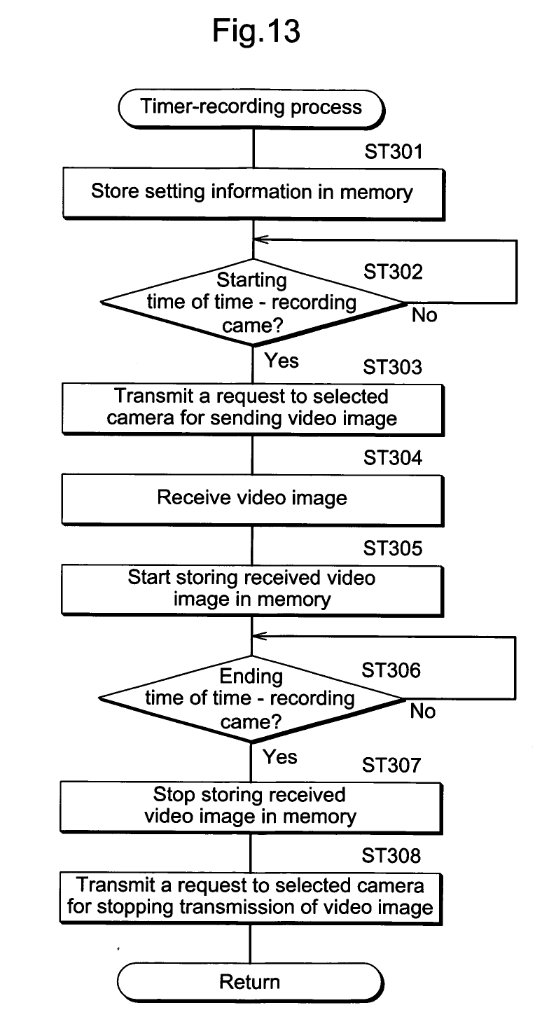

FIG. 13 is a flowchart illustrating a timer-recording process shown in step 107 of FIG. 7. When the desired network camera 3, the recording time, and the recording mode are input on the timer-recording screen shown in FIG. 12 for timer-recording, the setting information including the desired network camera 3, the recording time, and the recording mode is stored in memory 23 (step 301). Adapter apparatus 1 then goes into a record stand-by mode.

When it is determined that time comes to the starting time of the timer-recording based on the clock built in adapter apparatus 1 (step 302), a request for sending a video image to network communicator 11 is transmitted to the selected network camera 3 (step 303). Then, network communicator 11 receives the video image from the selected network camera 3 (step 304). After that, player/recorder unit 22 starts a process for storing in memory 23 the received video image (step 305).

Next, when it is determined that time comes to the ending time of the timer-recording based on the time built in adapter apparatus 1 (step 306), a process for storing in memory 23 the received video image is stopped (step 307). Then, a request for stopping the transmission of the video image is transmitted to the selected network camera 3 (step 308).

Further, adapter apparatus 1 performs a predetermined notification operation described below, when main controller 18 receives, from network camera 3 via network communicator 11, a detection signal. The detection signal is transmitted in response to detection of sensor 6 provided on network camera 3.

Adapter apparatus 1 includes notifier 24 that operates buzzer 25 and lamp 26 in response to a command from main controller 18. Upon receiving a detection signal from network camera 3, main controller 18 transmits, to notifier 24, the command for performing the predetermined notification operation. In the predetermined notification operation, buzzer 25 sounds and lamp 26 blinks. The predetermined notification operation instantly notifies the user of an error occurring in the locations where network camera 3 with sensor 6 is set.

FIG. 14 shows a sensor mode setting screen displayed on television receiver 4 as an operation screen for determining settings of sensor 6 provided on network camera 3. The user determines, on the sensor mode setting screen, whether or not to use a sensor mode function. The sensor mode function is utilized for performing the predetermined notification operation when main controller 18 receives, from network camera 3, a detection signal in response to detection of sensor 6 provided on network camera 3. The sensor mode setting screen is displayed by selecting “sensor mode” on the function select screen shown in FIG. 9.

On the sensor mode setting screen, display select section 151 shows whether the sensor mode is on or off. When the sensor mode is turned ON by pressing one of left and right cursor buttons 82 of remote controller 5, the predetermined notification operation is performed. In the predetermined notification operation, buzzer 25 sounds and lamp 26 blinks in response to detection of sensor 6.

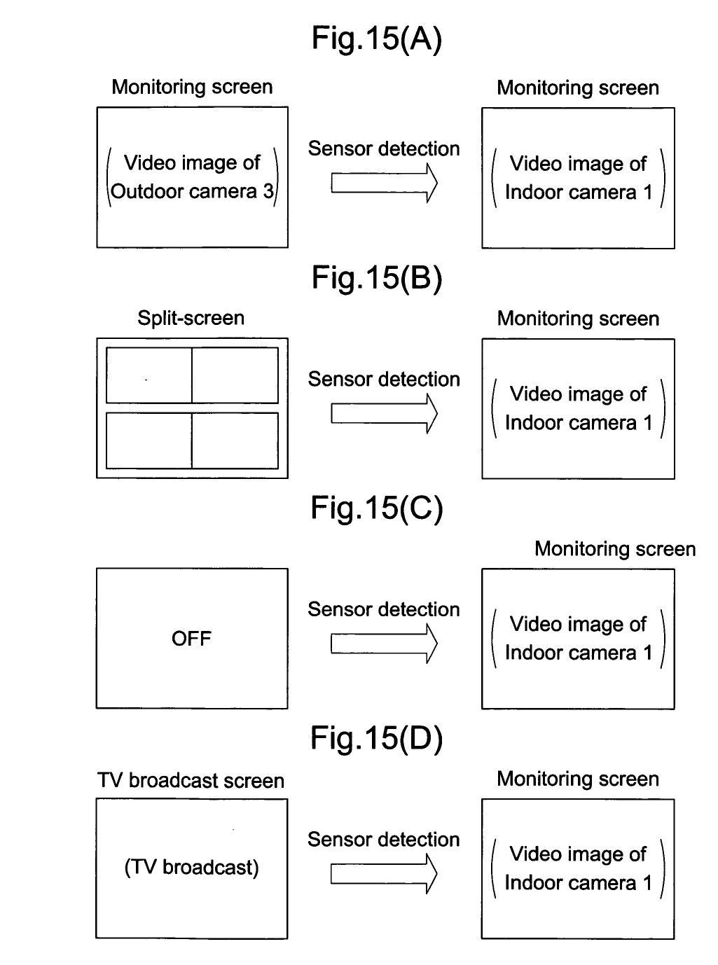

FIG. 15 shows how the screen changes on television receiver 4 when detection is made by sensor 6. In response to a detection signal from network camera 3, adapter apparatus 1 can control display controller 12 for another notification operation. This another notification operation displays video images captured by the network camera 3 corresponding to sensor 6 that has made the detection, prior to transmission of a video image from the other network cameras 3. Television receiver 4 is thus forced to switch to a screen displaying video images captured by the corresponding network camera 3 in response to the detection of sensor 6.

In the example shown in FIG. 15(A), when the detection signal is received from sensor 6, a video image captured by a network camera 3 other than the corresponding network camera 3 is being displayed. In this case, the screen displaying the video image captured by the noncorresponding network camera 3 is replaced by a screen displaying video images captured by the corresponding network camera 3.

As shown in the example in FIG. 15(B), when the detection signal is received from sensor 6, a split-screen is displayed on television receiver 4, the split-screen switches to a full-screen. The split-screen simultaneously displays video images captured by a plurality of network cameras 3. The full-screen exclusively displays video images captured by the network camera 3 corresponding to sensor 6. This screen switch operation may be limited to cases where video images captured by the network camera 3 corresponding to sensor 6 are displayed on the split-screen.

As shown in the example in FIG. 15(C), even when television receiver 4 is on standby, a control signal is transmitted, to television receiver 4, for resuming from the standby mode. Then, television receiver 4 may display video images captured by the network camera 3 corresponding to sensor 6 that has made detection. This process for transmitting the control signal to television receiver 4 is performed by television controller 28 shown in FIG. 1. Television controller 28 operates transmitter 7 to transmit a predetermined control signal in response to a command from main controller 18. This process turns ON television receiver 4 to display the video images captured by the network camera 3.

As shown in the example in FIG. 15(D), even when television receiver 4 is displaying broadcast program images, television controller 28 operates transmitter 7 to transmit the control signal for switching the display mode of television receiver 4. The broadcast program display mode is thus switched to the external input image display mode. The external input image display mode displays video images captured by the network camera 3 corresponding to sensor 6 that has made detection. The display mode of television receiver 4 is switched to the external input image mode. The video images captured by the network camera 3 are thus displayed on television receiver 4.

Main controller 18 of adapter apparatus 1 controls player/recorder unit 22 to perform a sensor-recording process. The sensor-recording process is utilized for recording video images captured by the network camera 3 corresponding to sensor 6 in response to a detection signal from the network camera 3.

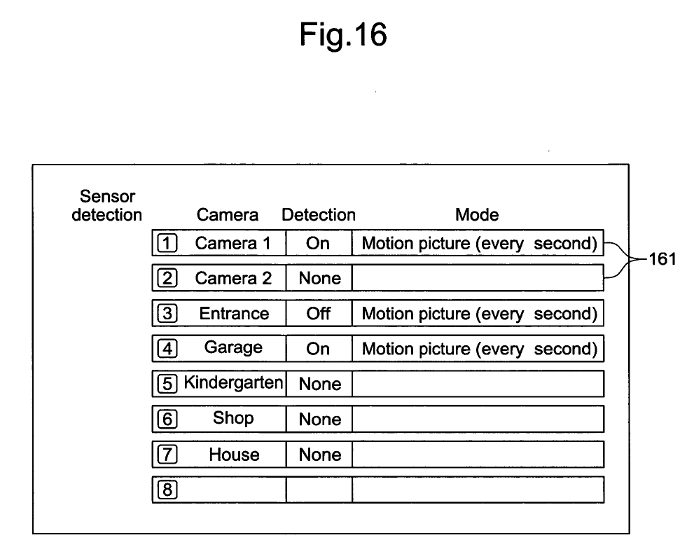

FIG. 16 shows a sensor detection setting screen displayed on television receiver 4 as an operation screen for determining various settings of sensor 6. The sensor detection setting screen is utilized for specifying, for each network camera 3, whether or not to perform the another notification operation in response to the detection of sensor 6. The sensor detection setting screen is also utilized for specifying a sensor-recording mode when the sensor-recording process is performed. The sensor detection setting screen is displayed by selecting “detailed settings” display select section 152 on the sensor mode setting screen shown in FIG. 14.

On this sensor detection setting screen, display select section 161 for each network camera 3 shows; whether or not to perform the another notification operation in response to the detection of sensor 6 (to turn ON or OFF a sensor mode), presence or absence of sensor 6, a message notifying that sensor 6 recording cannot be performed, and the sensor-recording mode of the sensor-recording process. The user specifies whether or not to perform the another notification operation for each network camera 3, by pressing left, right, up and down cursor buttons 82 of remote controller 5. In order to perform the sensor-recording process, the user first selects the sensor-recording mode. Further, the user turns ON the sensor mode on the sensor mode setting screen shown in FIG. 14. Then, the another notification operation, the screen switching operation and the sensor-recording process can be performed in response to the detection signal from sensor 6 provided on selected network camera 3: the another notification operation is performed by sounding buzzer 25 and blinking lamp 26, the screen switching operation is performed by switching the screen display to a screen displaying video images captured by the network camera 3 corresponding to sensor 6 that has made detection, and the sensor-recording process is executed in accordance with the selected sensor-recording mode.

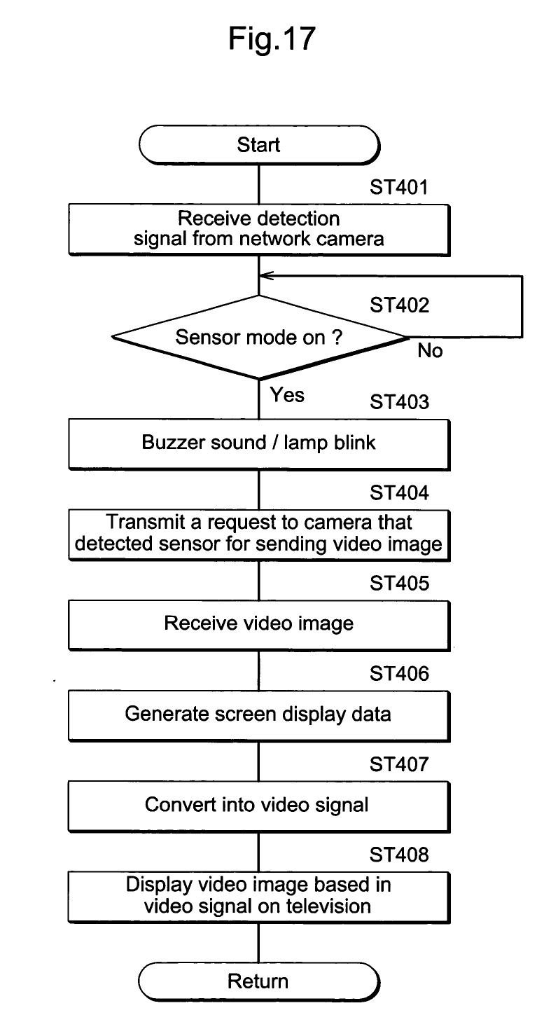

FIG. 17 is a flowchart illustrating the another notification process performed by adapter apparatus 1 shown in FIG. 1. Main controller 18 first receives, from network camera 3 via network communicator 11, a detection signal in response to detection of sensor 6 provided on network camera 3 (step 401). When the sensor mode is turned ON (step 402), main controller 18 transmits, to notifier 24, a command for performing the another notification operation. Then, buzzer 25 sounds and lamp 26 blinks (step 403).

Next, a process is performed for transmitting, to the network camera 3 corresponding to sensor 6 that has made detection, a request for sending a video image (step 404). Accordingly, network communicator 11 receives the video image from the network camera 3 (step 405); display controller 12 generates screen display data based on the video image (step 406); video signal generator 13 then converts the screen display data into video signals (step 407); and television receiver 4 displays the video image captured by the network camera 3 based on the video signals transmitted from video signal generator 13 (step 408).

Further, when the sensor-recording mode is active on the sensor detection setting screen shown in FIG. 16, network communicator 11 receives the video image from the network camera 3 (step 405). Player/recorder unit 22 then stores the video image in memory 23.

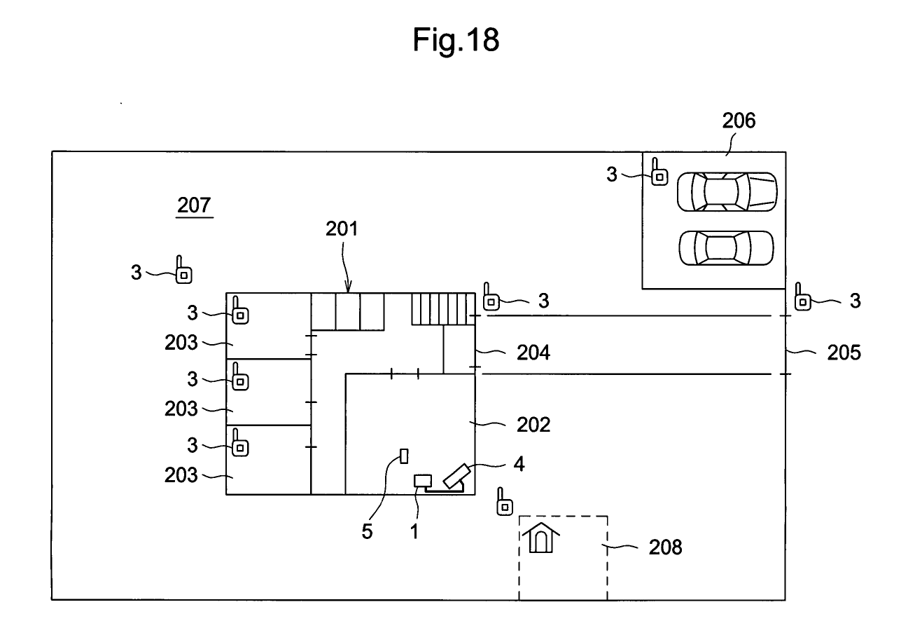

FIG. 18 shows an example of a network camera system configured with adapter apparatus 1 shown in FIG. 1. In this example, adapter apparatus 1 and television receiver 4 are provided in living room 202 within residence 201. Further, network cameras 3 are provided in rooms 203 within residence 201, entrance 204, gate 205, garage 206, garden 207 and pet space 208. Network cameras 3 are configured to perform wireless network communications with adapter apparatus 1, thereby enabling the user to monitor, on television receiver 4 in living room 202, situations in each location of residence 201 and to record them.

The above configuration can prevent strangers and burglaries from intruding into the house, and can improve the security of the house. It also improves convenience for nursing care by allowing the user to monitor those who require care. Moreover, the system can be used for the purpose of hobbies and entertainment. This allows the user to observe a pet, plants in a garden, etc. and to record them.

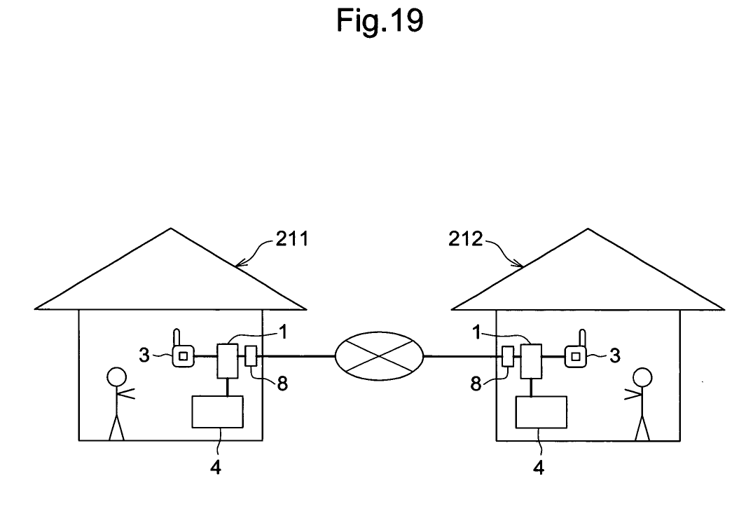

FIG. 19 shows another example of a network camera system configured with adapter apparatus 1 shown in FIG. 1. In this example, adapter apparatuses 1, network cameras 3 and television receivers 4 are provided in two remotely located residences 211 and 212. Adapter apparatuses 1 of residences 211 and 212 are respectively connected to the Internet via routers 8 provided in residences 211 and 212. Further, adapter apparatus 1 provided in residence 211 registers network camera 3 provided in residence 212, while adapter apparatus provided in residence 212 registers network camera 3 provided in residence 211. Therefore, the television receiver in one residence can display the state of the other residence, thus enabling communications between parties at distant places.

The network camera system may be applied to more residences than described in this example. In that case, it is further possible for parties at three or more different locations to talk simultaneously while looking at each other. Those parties can display video images captured by network cameras 3 on a split-screen at each television receiver 4.

In the network camera system for a plurality of residences shown in FIG. 19, it is possible to monitor other residences by displaying, on television receiver 4 within a residence, video images captured by network cameras 3 provided at given locations within another residence. This configuration allows the user to use the system, for example, to confirm the safety of an old person living alone in a remote place.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2005-259241 filed on Sep. 7, 2004 and the Japanese Patent Application No. 2005-186302 filed on Jun. 27, 2005, entire content of which is expressly incorporated by reference herein.

What is claimed is:

1. An adapter apparatus connected to a network camera and to a television receiver, the adapter apparatus comprising:
an input device configured to receive a control signal, the control signal being utilized for controlling the network camera; and
a controller configured to receive, from the network camera, a video image which the network camera captures, and to transmit the video image to the television receiver,
the controller being further configured to:
determine whether the control signal is received by the input device, while when the video image is displayed on the television receiver; and
control the network camera based on the received control signal, the network camera transmitting the video image to the television receiver via the adapter apparatus, when it is determined that the control signal is received by the input device.

2. An adapter apparatus connected to a network camera and to a television receiver, the adapter apparatus comprising:
an input device configured to receive a control signal, the control signal including one control signal and another control signal, the one control signal being utilized for displaying on the television receiver an operation screen for controlling the network camera, the another control signal being utilized for controlling the network camera while the operation screen is displayed on the television receiver; and
a controller configured to receive, from the network camera, a video image which the network camera captures, and to transmit the video image to the television receiver,
the controller being further configured to:
generate operation screen data related to the operation screen based on the one control signal, when the one control signal is received by the input device;
transmit the operation screen data to the television receiver;
receive the another control signal by the input device, while the operation screen is displayed on the television receiver based on the operation screen data;
determine whether the another control signal is associated with the operation screen displayed on the television receiver;
control the network camera based on the another control signal, when it is determined that the another control signal is associated with the operation screen.

3. The adapter apparatus according to claim 1, wherein the input device receives the control signal from an external remote controller via a wireless communication.

4. The adapter apparatus according to claim 1, wherein the controller converts an image signal the video image received from the network camera into an image signal compatible with the television receiver.

5. The adapter apparatus according to claim 2, wherein the operation screen is displayed on the television receiver so as to be superimposed on the video image displayed on the television receiver.

6. The adapter apparatus according to claim 2, wherein the one control signal is utilized for displaying the operation screen to adjust a viewing angle of the network camera horizontally, and the another control signal is utilized for controlling the network camera to move the viewing angle of the network camera right or left.

7. The adapter apparatus according to claim 2, wherein the one control signal is utilized for displaying the operation screen to adjust a viewing angle of the network camera vertically, and the another control signal is utilized for controlling the network camera to move the viewing angle upward or downward.

8. The adapter apparatus according to claim 2, wherein the one control signal is utilized for displaying the operation screen to adjust zooming of the network camera, and the another signal is utilized for controlling the network camera to zoom in or out.

9. The adapter apparatus according to claim 2 further being connected to a plurality of the network cameras, wherein the controller generates split-screen data as the operation screen data, the split-screen data including a plurality of display windows, each of the plurality of the display windows separately displaying each of video images captured by the plurality of the network cameras.

10. The adapter apparatus according to claim 9, wherein the plurality of the network cameras are registered in the adapter apparatus.

11. The adapter apparatus according to claim 9, wherein the plurality of the network cameras are selected, based on the control signal input from the input device.

12. The adapter apparatus according to claim 1 further comprising a memory, wherein the controller records, in the memory of the adapter apparatus, the video image received from the network camera, based on the control signal input from the input device.

13. The adapter apparatus according to claim 12, wherein the control signal indicates predetermined date and time for recording in the memory of the adapter apparatus the video image.

14. An adapter apparatus connected to a plurality of network cameras and to a television receiver, one sensor being provided on each of the plurality of the network cameras, the one sensor detecting an object coming into a predetermined area of the network camera corresponding to the one sensor and issuing an detection signal, the adapter apparatus comprising:
an input device configured to receive the detection signal from the one sensor, the detection signal indicating that an object has come into the predetermined area of the network camera corresponding to the one sensor; and
a controller configured to receive, from the plurality of the network cameras, video images which the plurality of the network cameras capture;
the controller being further configured to:
determine whether the input device receives the detection signal from the one sensor;
transmit, to the television receiver, the video image which the network camera corresponding to the one sensor captures, prior to transmission of a video image from the other network cameras, when it is determined that the input device receives the detection signal from the one sensor.

15. The adapter apparatus according to claim 14, wherein the controller notifies to a user of the adapter apparatus that an object has come into a predetermined area of the network camera corresponding to the one sensor.

16. The adapter apparatus according to claim 15, wherein the controller notifies the user of the adapter apparatus, using a sound.

17. The adapter apparatus according to claim.15, wherein the controller notifies the user of the adapter apparatus, using a light.

18. The adapter apparatus according to claim 14, wherein the controller converts an image signal of the video images received from the network cameras into an image signal compatible with the television receiver.

19. The adapter apparatus according to claim 14 further comprising a memory, wherein the controller records, in the memory of the adapter apparatus, the video image received from the network camera corresponding to the one sensor, when it is determined that the input device receives the detection signal from the one sensor.

20. A method for controlling a network camera using an adapter apparatus, the adapter apparatus being connected to the network camera and to a television receiver, the method comprising:
receiving a control signal, the control signal being utilized for controlling the network camera;
receiving, from the network camera, a video image which the network camera captures, and to transmit the video image to the television receiver,
determining whether the control signal is received by the input device, when the video image is displayed on the television receiver; and
controlling the network camera based on the received control signal, the network camera transmitting the video image to the television receiver via the adapter apparatus, when it is determined that the control signal is received by the input device.
